(19) United States
(12) Patent Application Publication
(10) Pub. No.: US 2013/0159324 A1
(43) Pub. Date: Jun. 20, 2013

(54) Multi-Source Multi-Step Search in Enterprise Software Systems

(71) Applicants: Yiwen Xu, Brossard (CA); Mu Shen, Brossard (CA); Evelyna Holban, Laval (CA); Sebastien Phan, Montreal (CA); Xiaohua Xian, Brossard (CA); Ming Hao Xie, Montreal (CA); Bernd Reimann, La Prairie (CA)

(72) Inventors: Yiwen Xu, Brossard (CA); Mu Shen, Brossard (CA); Evelyna Holban, Laval (CA); Sebastien Phan, Montreal (CA); Xiaohua Xian, Brossard (CA); Ming Hao Xie, Montreal (CA); Bernd Reimann, La Prairie (CA)

(73) Assignee: SAP AG

(21) Appl. No.: 13/326,130

(22) Filed: Dec. 14, 2011

(51) Int. Cl. G06F 17/30

(52) U.S. Cl. 707/754; 707/E17.059

(57) ABSTRACT

A search query is received that is associated with two or more data sources so that a source-specific query is generated for each data source using a data source definition associated with the corresponding data source and the search query. Thereafter, searches are executed for a first set of data sources using the corresponding source-specific queries. These search results from the first set of data sources are consolidated. In addition, searches are executed for a second set of data sources using the corresponding source-specific queries. These search results from the second set of data sources are then consolidated with the consolidated search results from the first set of data sources. In some implementations, at least one search comprises a main search followed by a sub-search that filters results from the main search. Related apparatus, systems, techniques and articles are also described.

### TECHNICAL FIELD

The subject matter described herein relates to a multi-source multi-step search technique within an enterprise software system such as a business object-based enterprise software system.

### BACKGROUND

Customer relationship management (CRM) and Enterprise Resource Planning (ERP) systems are storing increasingly greater amounts of information about both prospective customers and actual customers of enterprises. For example, call center agents can receive hundreds and thousands calls from customers every day. Such contacts with the customers generate a huge number of interaction records (sometimes within heterogeneous systems). For example, a system of a utility company with about 4.5 million customers can create more than 30,000 new interaction records per day. Given the short amount of time available to both the call service agents and the customers, it is important for the call service agents, using the ERP/CRM system, to be provided with quick and intuitive access to any relevant information encapsulated within the interaction records.

### SUMMARY

In a first aspect, a search query is received that is associated with two or more data sources so that a source-specific query is generated for each data source using a data source definition associated with the corresponding data source and the search query. Thereafter, searches are executed for a first set of data sources using the corresponding source-specific queries. These search results from the first set of data sources are consolidated. In addition, searches are executed for a second set of data sources using the corresponding source-specific queries. These search results from the second set of data sources are then consolidated with the consolidated search results from the first set of data sources. In some implementations, at least one search comprises a main search followed by a sub-search that filters results from the main search.

The following describes variations which can be implemented singly or in combination. User-generated input can be received via a graphical user interface specifying the search query. At least one of the first set of data sources and the second set of data sources includes only one data source. The second consolidating (i.e., the consolidation of the search results of the second set of data sources with the consolidated results from the first set of data sources) can include finding a set of common entries from the search of the first set of data sources and from the search of the second set of data sources. The consolidated search results can be displayed in a computing display, persisted and/or transmitted to a remote computing system.

At least a portion of the searches of first set of data sources can be executed in parallel and/or at least a portion of the searches of the second set of data sources can be executed in parallel. At least a portion of the searches of first set of data sources can be executed serially and/or at least a portion of the searches of the second set of data sources can be executed serially. At least a portion of the searches of first set of data sources can be executed in parallel to at least a portion of the searches of the second set of data sources. In some implementations, the searches of the second set of data sources are executed only after the searches of the first set of data sources are completely executed. The searches of the second set of data sources can be further limited by the consolidated search results from the first set of data sources.

Searches can be executed for a third set of data sources using corresponding source-specific queries. With such an arrangement, the third set of data sources can have a lower priority than both of the first set of data sources and the second set of data sources. These search results from the third set of data sources can be consolidated with the search results consolidated from both of the first set of data sources and the second set of data sources.

The sub-search can filter the results of the main search using object neighborhood search and/or categorization. Source-specific queries for two different data sources can query data encapsulated in common business objects. The data source definitions can specify priority levels for the data sources, and the second set of data sources can have a lower priority than the first set of data sources. In addition, a search strategy can be determined and used for performing the various searches.

In an interrelated aspect, a search query is received that is initiated by a user via a graphical user interface. The search query identifies a customer and seeking one or more interaction records associated with the customer. Thereafter, the search query is associated with two or more data sources. Using this association, a source-specific query is generated for each data source using a data source definition associated with the corresponding data source and the search query. Searches are then executed for a first set of data sources using the corresponding source-specific queries and the results of these searches are consolidated. Searches for a second set of data sources are also executed using the corresponding source-specific queries (with the second set of data sources having a lower priority than the first set of data sources). Thereafter, the search results from the second set of data sources are consolidated with the consolidated search results from the first set of data sources.

Articles of manufacture are also described that comprise computer executable instructions permanently stored on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. In addition, methods can be implemented by one or more data processors either within a single computing system or distributed among two or more computing systems.

The subject matter described herein provides many advantages. For example, the current subject matter provides more targeted searches as compared to conventional systems with quicker response times while consuming fewer processing resources. In addition, the current subject matter is advantageous in that it provides a user with an enhanced interaction overview that contains the most important data of interaction records for a particular customer and which also allows easy selection capabilities, fast search, swift filtering and navigation.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating querying of multiple data sources;

FIG. 2 is a diagram illustrating an application server for use with a system such as illustrated in FIG. 1;

FIG. 3 is a diagram illustrating how data sources and corresponding search fields can be defined;

FIG. 4 is a diagram illustrating example search criteria to form the basis of a search query;

FIG. 5 is a diagram illustrating a multi-step search of a data source;

FIG. 6 is a first process flow diagram illustrating a multi-source multi-step search;

FIG. 7 is a diagram illustrating a view of SAP Interaction Center software powered by a multi-source multi-step search engine; and

FIG. 8 is a second process flow diagram illustrating a multi-source multi-step search.

Like reference symbols in the various drawings indicate like elements.

### DETAILED DESCRIPTION

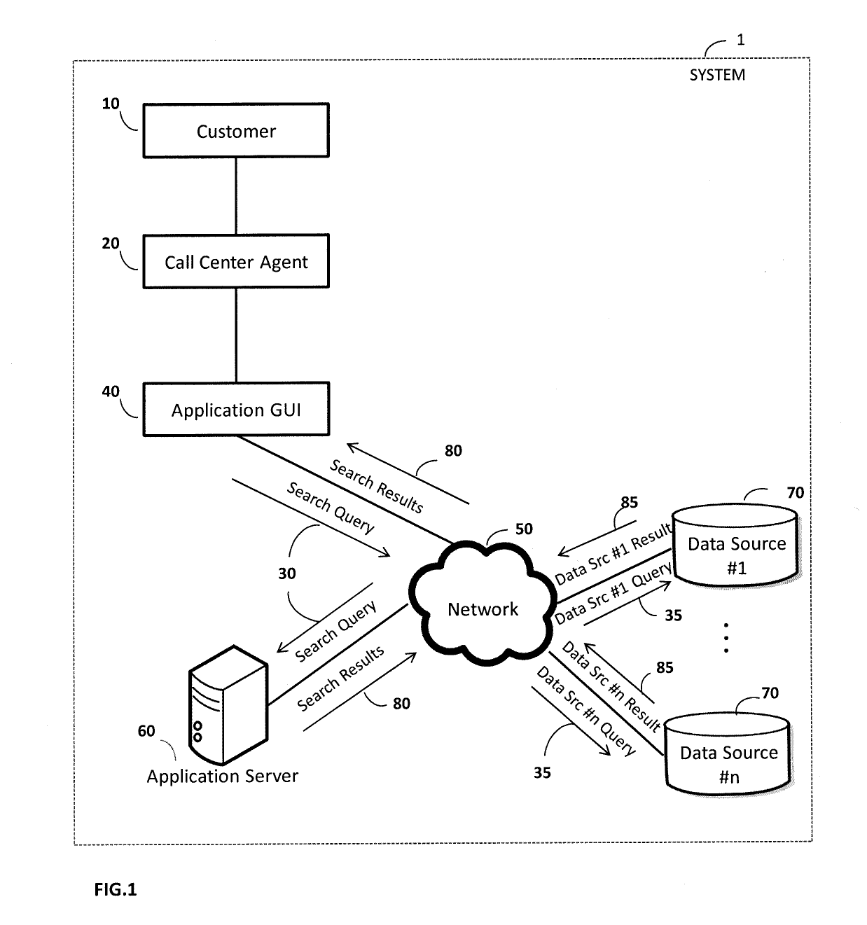

FIG. 1 is a diagram illustrating a system 1 where a multi-source multi-step (MS2) search is performed. A customer 10 can call a call center agent 20 of a service provider. The call center agent 20 can then talk to the customer 10 and enter search criteria (relating to the customer 10 and/or an inquiry by the customer 10) via application graphical user interface (GUI) 40 to initiate a search. The application GUI 40 can send search query 30 (which is based on the entered search criteria) to application server 60 through a communication network 50 (e.g., the Internet, a local network, etc.).

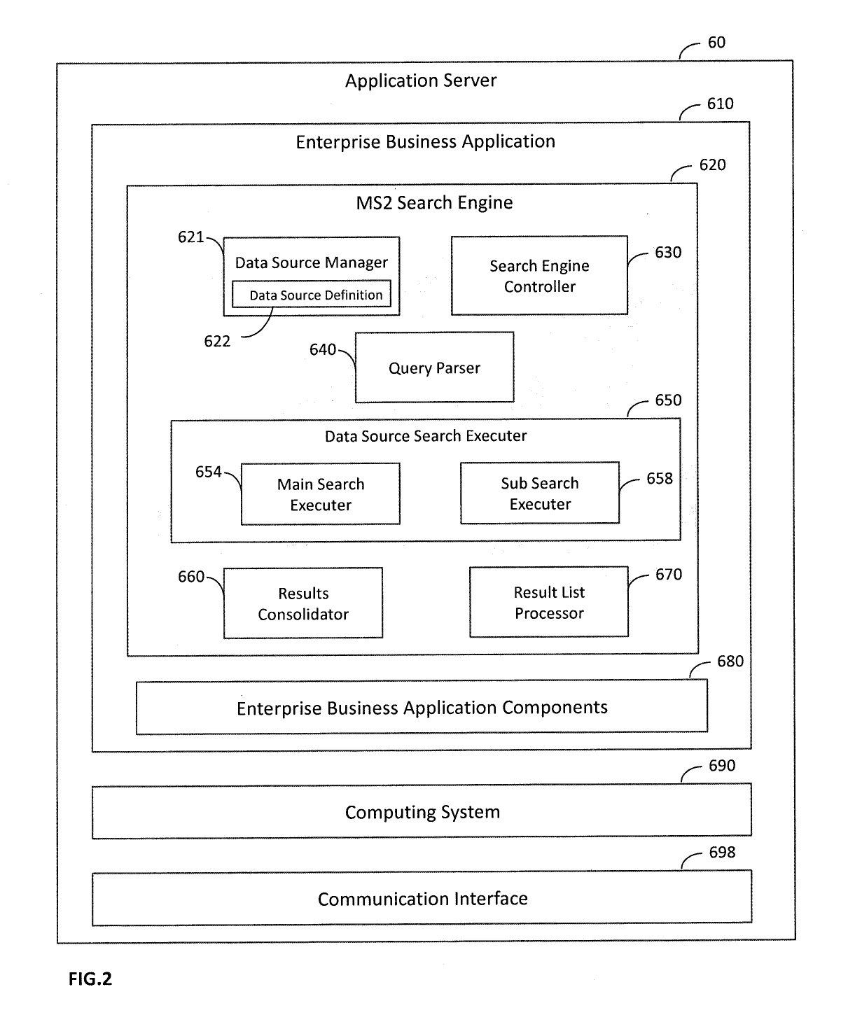

The application server 60, via a MS2 search engine 620 (as illustrated in FIG. 2), can parse search query 30 and generate a data source-specific search query 35 for each data source 70 defined in data source definition 622 (see FIG. 2). In addition, the MS2 search engine 620 can query each data source 70 in parallel or in sequence (using the corresponding data-source specific query 35).

The data source(s) 70 can, for example, be relational database management system instances, or any searchable data systems (and the data sources 70 can have heterogeneous formats). The data sources 70 can reside on two or more different physical computer servers, or reside in a same physical computer server. A data source 70 can also reside in the application server 60.

The data source(s) 70 can receive a data source-specific search query 35, perform the required search, and send back data source-specific search result 85 to the application server 60. The application server 60, after receiving data source-specific search results 85 from each data source 70 can consolidate search results, using the MS2 search engine 620, to form search result 80. The search result 80 can then be sent to be rendered in application GUI 40 for the call center agent 20 to review and/or manipulate.

FIG. 2 is a diagram illustrating an enterprise business application server 60. The application server 60 can include communication interface 698, computing system 690 which includes necessary hardware and software to carry out computation tasks, and the enterprise business application 610. The enterprise business application 610 can have a collection of enterprise business application components 680 to carry out different business transactions. The enterprise business application 610 can also include the MS2 search engine 620 which can wholly be responsible for controlling and executing multi-source search requests.

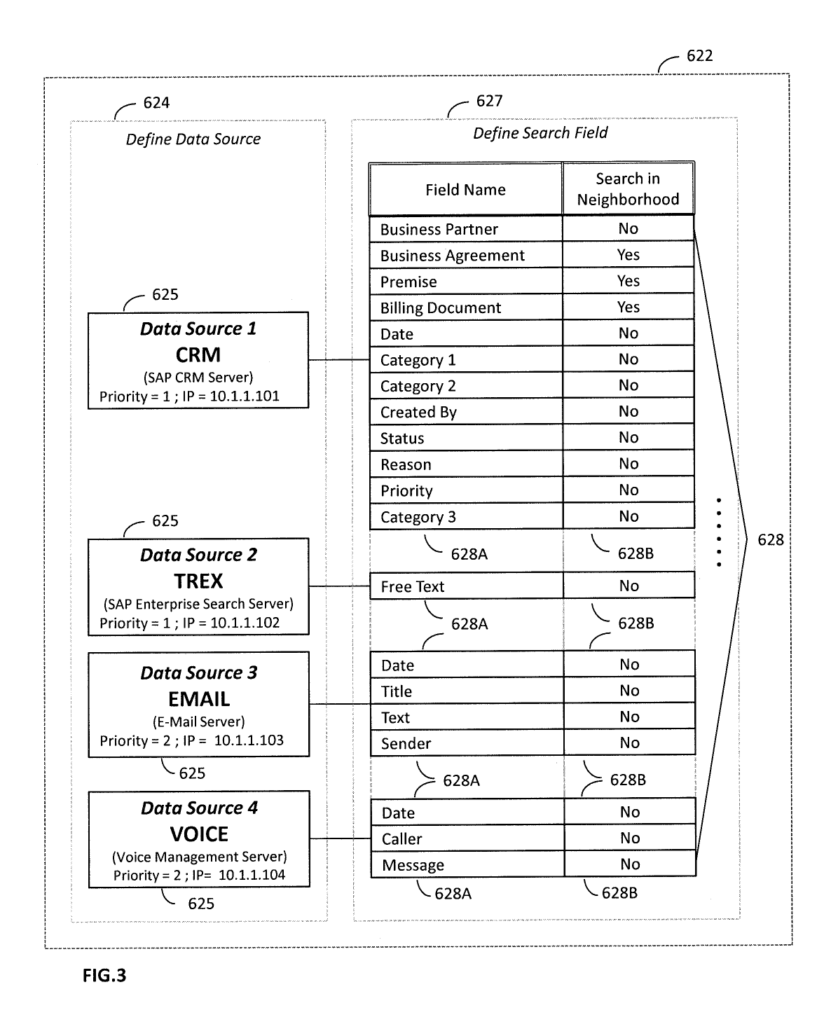

The MS2 Search Engine 620 can comprise one or more of the following components: data source manager 621, search engine controller 630, query parser 640, data source search executer 650, result consolidator 660 and result list processer 670. The data source manager 621 can read and maintain data source and search field definition(s) 622 (see also FIG. 3). The search engine controller 630 can create a data source search executer 650 for each data source 70 defined in data source and search field definition 622. The search engine controller 630 can also receive search query 30 from application GUI 40 and ask query parser 640 to parse search query 30 so that a data source-specific search query 35 can be formed for each data source 70. The search engine controller 630 can also update a data source-specific search query 35 from a previous search result. Furthermore, the search engine controller 630 can receive search result(s) from data source executer 650 and pass such result(s) to result consolidator 660 for consolidation (as described herein). The search engine controller 630 can then call result list processor 670 to populate all required display-only fields.

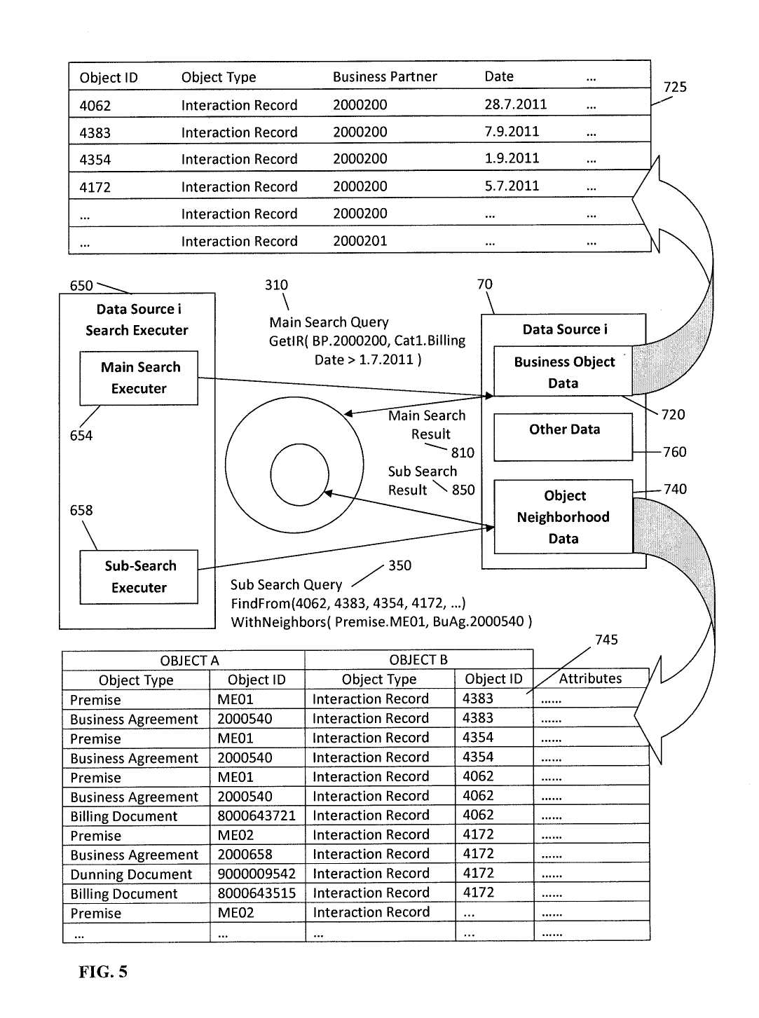

The query parser 640 can parse search query 30 according to the data source and search field definition 622 so that a data source-specific query 35 can be generated for each data source 70. The data source search executer 650 can include two elements, a main search executer 654 and a sub search executer 658. The data source search executer 650 can partition the data source-specific query 35 to data source-specific main search query 310 and sub-search query 350 (see FIG. 5). The data source search executer 650 can also carry out a main search (using the main search query 310) via the main search executer 654 and a sub-search (using the sub-search query 350) via the sub-search executer 658.

The result consolidator 660 can consolidate current search result(s) from the data source 70 with previous search results. A consolidation, in this regard, is to find a common set of entries from the current and previous search results. This common set becomes the consolidated search result of the current and previous search results. In another feature, a consolidation is to combine the current search result to the previous search result to form a consolidated search result. The result list processor 670 can populate all display-only fields that are required to be rendered/displayed in the application GUI 40.

FIG. 3 is a diagram illustrating how data sources and corresponding search fields can be defined. There can be two parts in the data source and search field definition 622, namely data source definition table 624 and search field definition table 627. In data source definition table 624, multiple data sources can be defined. For each data source characteristics such as name, IP address, search priority, search object, and the like can be specified. In FIG. 3, four data source definitions 625 are defined in the data source definition table 624.

Table 627 of FIG. 3 shows how search fields can be defined. For each data source definition 625, multiple search fields can be defined. A search field definition 628 can have a name 628A and a flag 628B indicating whether this search field needs to be run in a neighborhood search (i.e., a search of linked business objects, etc.). A same search field name can appear in one or more data source definitions. Other display-only fields can also be specified in the definition. A quotation document or a contract document, etc. can be created using the Interaction Center software in CRM. When such a document is created in CRM, an interaction record is created and the document is linked to the interaction record by default. While a billing document, or an invoice document, or a dunning document, etc. is created in ERP, it is stored in ERP but accessible from CRM using, for example, a remote function call. When a billing document, or a dunning document, is created for a customer in ERP, it might not be linked to any interaction record created in CRM or in ERP. There are many different ways to link an interaction record to such a document created using a back-office process. One practical way is that at the moment when a customer calls about a document and the agent views this document, a new interaction record is then created with a link to this document. It is also possible that before one object instance is linked to another, the two object instances already exist, in a same data source, or in two different data sources. They both exist but are not linked to each other. When one billing document is made linked to an interaction record, the billing document becomes a “neighbor” of the interaction record. For a given business object instance, all business object instances that are linked to it form the neighborhood of the business object instance. Thus, when the “Search in Neighborhood” flag is set to YES for a search field in the search field definition, it tells the system that for the data source that owns this search field, this search field name represents another business object and a neighborhood search is required to retrieve linked object instances if any.

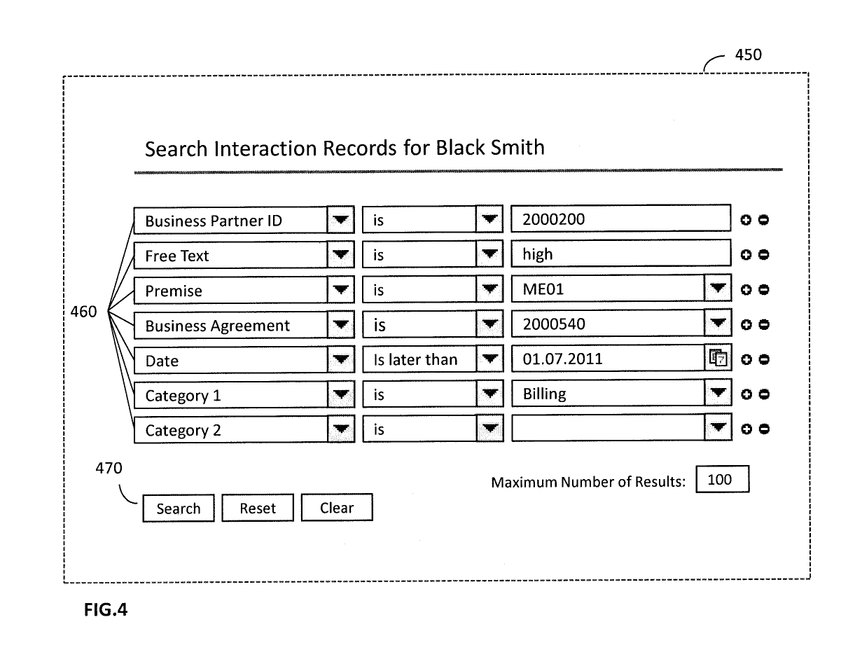

FIG. 4 is a diagram illustrating an example of search criteria 450. In this example, there are seven search fields 460: business partner ID, free text, premise, business agreement, date, category 1 and category 2. Each search field 460 represents a simple search criterion. For example, the first search field in this example looks for business partner with ID being 2000200. Each search field 460 can be a triplet of search field Name, Operator, and Values. The Values can be a single value, or a pair of values, or a set of more than 2 values. When the Operator is “IS”, there is only one value required for a simple search criterion; if “BETWEEN” is provided and chosen as Operator, two values are required. Hence, the second search field 460 can look for any instance of Interaction Record which includes a text string “high” in its description, or notes, or values of attributes. As described below, the notation Name.Value can be used to specify a simple search criterion with operator IS (e.g., Premise.ME01 means “Premise is ME01” or “Premise ID=ME01”, etc.).

In an interaction with a customer 10, the call center agent 20 can fill search criteria 450 (which is rendered in the application GUI 40) with one or more search fields 460 depending on the situation that the agent encounters. When the call center agent 20 is ready to start a search, the agent can activate a search button 470. At this point, the application GUI 40 can then take the search criteria and convert it to a formatted search query 30 and send the formatted search query 30 to the application server 60 via a communication network 50. Additional fields 460 can be added, for example, by clicking on graphical user interface element “+”, and similarly, fields 460 can be removed by clicking on graphical user interface element “−”. Two different simple search criteria as specified in 460 with different search field names can be considered as “AND” in the search. It is possible that a same search field name appear 2 or more times in the search criteria 450. For example, the search criteria 450 can have the search field Premise appeared twice: the first being Premise.ME01 and the second being Premise.ME02. In this case, two different simple search criteria as specified in 460 with a same search field name can be considered as “OR” in the search. In addition, search field names can be presented in a list that can be viewed by clicking on the arrow-down graphical user interface element. This list can include all searchable fields which are defined in the data source and search field definition 622.

FIG. 5 is a diagram that illustrates, for a given data source 70, how a main search can be executed by a main search executer 654; a corresponding sub-search can be executed by a corresponding sub-search executer 658; and how the result of the main search can influence the execution of the sub-search. As stated above, data source search executer 650 can comprise main search executer 654 and sub-search executer 658. Data source search executer 650 can receive data source-specific search query 35 and partition the query 35 into a main search query 310 and a sub-search query 350. The data source search executer 650 can then call the corresponding main search executer 654 to carry out a main search using the main search query 310 and call the corresponding sub-search executer 658 to carry out a sub-search with sub-search query 350. In addition, the data source 70 can also have other data 760 that are not inquired by this search query.

In one use-case as illustrated in FIG. 5, a main search query 310 is specified to find and return all interaction records which were created after the date of Jul. 1, 2011 (which references Jul. 1, 2011) and in which Category1 is Billing for Business Partner 2000200. This query will reach out to those tables that store the interaction records with specified conditions 310 from business object data 720 of data source 70. Interaction record entries 725 are examples of those business object data. Main search query 310 applying to entries 725 results in a main query result 810 being the Interaction record entries (4062, 4383, 4354, 4172, . . . ).

With further reference to FIG. 5, the sub search query 350 is to find, from the set of interaction records (4062, 4383, 4354, 4172, . . . ), those interaction records which are linked to Premise.ME01 and BuAg.2000540, where Premise.ME01 means premise ID being ME01, and so on so forth. This query will reach out to those tables that define object neighborhood data 740. For a given business object, all business objects that are linked to it forms the neighborhood of the business object. Each row 745 shows a linkage of a business object to an interaction record object. For instance, the first row shows a Premise object ME01 is linked to the interaction record 4383. Sub-search query 350 applying to entries 745 gives a sub-query result 850 being the interaction record entries (4062, 4383, 4354). When the sub-search is completed, the sub-search result 850 will be considered as the search result 85 of this data source 70.

In SAP systems, an interaction record can be created with standard SAP Business Object attributes; categorized with one or more categorizations (schemas) in multiple levels; linked to multiple Business Objects using Document Flow; and/or linked to customer defined external object(s). Standard SAP Business Object attributes include: ID, Description, Date, Created By, Status, Notes, etc. With SAP systems, a categorization can include up to 6 levels. Business Objects linked to an interaction record could be, for example, a Business Agreement, or a Billing Document, or a Utility Premise, or other business objects.

It will be appreciated that interaction records can take a wide variety of forms. In addition, customer defined external object(s) could be any object stored in a non-SAP system, for example, emails or Interactive Voice Response records. In Non-SAP systems, an interaction record can be created and maintained with links to objects modeled with many-to-many relationship. A search/filtering method as described herein can find all interaction records for complex search criteria, such as: created for the given Business Partner for the past three months; and status is In Process; and with categorization Billing-Incorrect Bill-Incorrect Billing Rate; and linked to Premise 101 and Business Agreement 7021 and a Billing Document; and Free text includes “small business customer”.

There are many different variants that can be implemented for the main/sub search mechanism. The above example provides an arrangement in which both the main search and sub-search reach out to the data source 70 to make certain selections. In one variation, a sub-search can be executed while a main search is not directly executed. As an example, the call center agent 20 performed a first search which is a full main/sub search. The call center agent 20 then makes a small modification to the search criteria which only affects linked business objects and does another search. This search does not need a main search (because it only affects linked business objects) and so only a new sub-search is needed and the sub-search will be carried out on the result set of the previous main search.

In yet another implementation, only a main search can be executed while no sub-search is carried out. As an example, when the call center agent 20 confirms with the customer 10 and goes to the application GUI 40 that shows an interaction record overview the first time, there are no search criteria specified—the agent 20 has no opportunity at this initial stage to specify any search criteria. The system, at this point, can perform only a main search and no sub-search. The system displays the search result of the main search in the application GUI 40 and then waits for and receives from the call center agent 20 further search criteria before performing a sub-search. In the case that no sub-search involved, the main search result 810 can be considered as the search result 85 of this data source 70.

In a further implementation, a main search can be followed by two or more sub-searches before a final search result is displayed. In this feature, the sub-search executer 658 carries out two or more sub-search queries 350 to retrieve data from object neighborhood tables 740.

In addition, it will be appreciated that the example of a call center agent 20 is for illustration purposes and that other arrangements can be implemented. For example, the application GUI 40 can be part of a web application that the customer 10 or other user directly logs into in order to review his or her account and search for related interaction records.

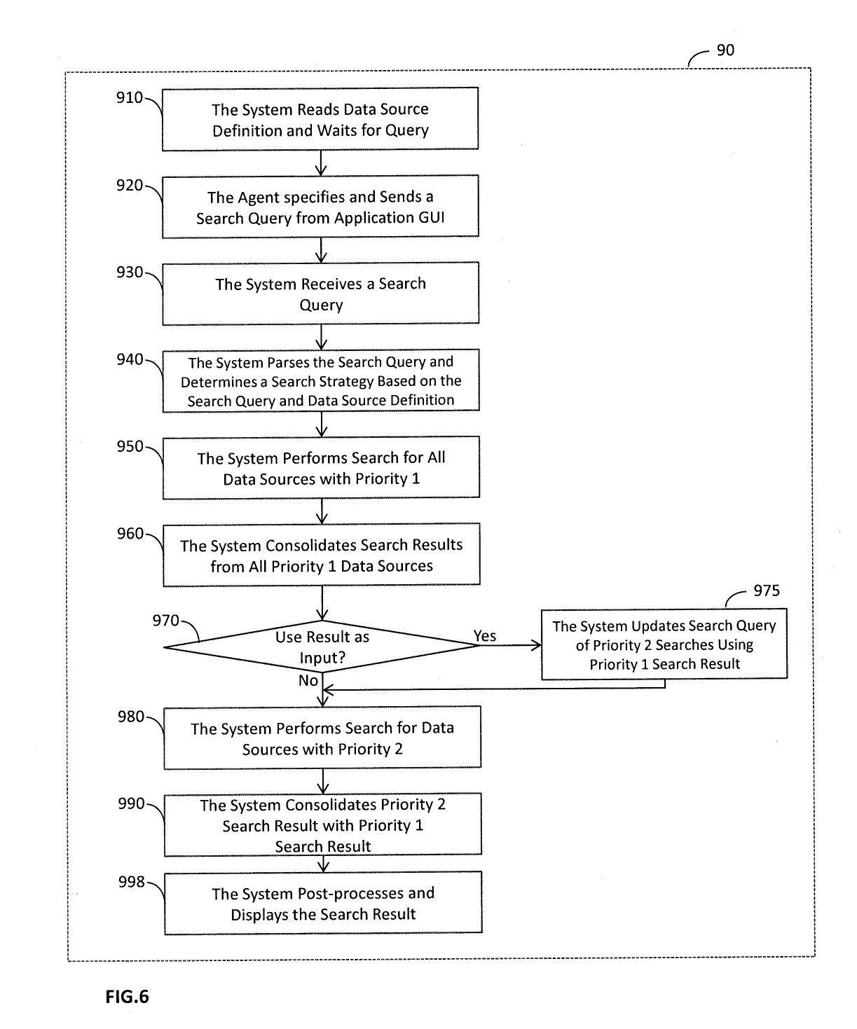

FIG. 6 is a process flow diagram illustrating an example process for performing an MS2 search. When being launched, the MS2 engine 620, at 910, can read data source definition data 622 and wait for query requests. The system can create a data source-specific search object for each data source 70 defined in data source definition. The call center agent 20 receives a call from a customer 10, gets questions from the customer 10, and can enter search input via the application GUI 40 and activate the search button to send, at 920, a search request. The MS2 search engine 620 can then, at 930, receive the search request.

The query parser 640 of the MS2 search engine 620 can, at 940, parse the search query and then determine a search strategy based on the search query and any data source definition input. For example, assume four data sources 70 are defined in the application server 60, having data sources 70₁ and 70₂ with search priority 1 and data sources 70₃ and 70₄ with priority 2; further assume that from a search request, the MS2 search engine 620 can identify search fields only for data sources 70ₖ, 70₂ and 70₄. Then a search strategy could be: first to search data sources 70₁ and 70₂ in parallel, consolidates search results from data sources 70₁ and 70₂ by finding a common set, and finally search data source 70₄ using the consolidated search result as input together with other search parameters.

The system can, at 950, perform searches for those data sources 70 with search priority 1 determined by the search strategy, in parallel or not in parallel, specified by the search strategy. The system can search a data source 70 using a specific search executer 650 for the corresponding data source 70. The system can pass a data source-specific query 35 to the search executer, allow the data source search executer 650 to complete the search, and receive a search result from the data source search executer 650.

Thereafter the system can, at 960, consolidate search results for all priority 1 data sources. The consolidated search result of previous searches might be chosen as input to a next round search. The system can, at 970, check if a pre-defined condition has been reached so that the consolidated search result of previous searches should be taken as input to a next round search. If the condition has been satisfied, the system can, at 975, update search query for the next priority 2 search using the consolidated search result of all priority 1 searches.

Subsequently, the system can, at 980, perform search for the priority 2 data sources 70. The system can, at 990, consolidate the priority 2 search results with the priority 1 search results. It will be appreciated that operations 970, 975, 980 and 990 can be be repeated if more data sources 70 exist and have been attached with a different search priority (e.g., search priority 3 or 4, etc.) in the search strategy determined as part of operation 940. The system, at 998, can display the search results. The system needs to populate all required, but not yet filled, non-search (fields that are not search fields but need to be displayed) fields before the application GUI 40 displays the search result.

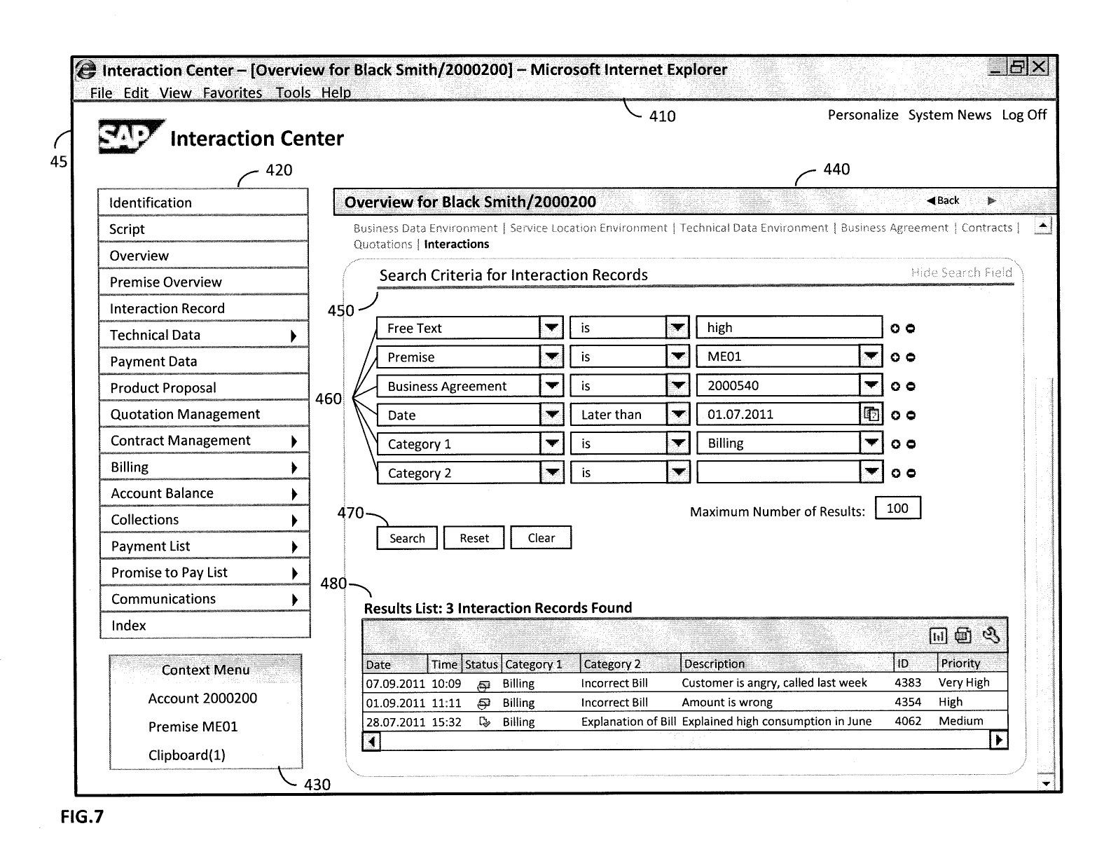

FIG. 7 is a screenshot illustrating a sample view 45 of SAP Interaction Center software powered by a MS2 search engine 620 as described herein. The view 45 can comprise a navigation bar 420 and a Context Menu area 430 where business objects related to the business partner, if confirmed, are displayed. A title 440 of the view 45 can be displayed as well as search criteria 450. In a results list 480, search results returned by the MS2 search engine 620 matching the search criteria 450 can be displayed/characterized.

In one example, a system is provided for a utility company with a large number of customers. The system includes an SAP ERP handling back-office activities and CRM for Utilities which is incorporated with an SAP Interaction Center and SAP TREX Enterprise Search. When such a document is created in CRM, an interaction record is created and the document is linked to the interaction record by default. A billing document, or an invoice document, or a dunning document, etc., however, is created in ERP, but accessible from CRM using, for example, a remote function call. When a billing document, or an invoice document, or a dunning document, is created for a customer in ERP, it might not be linked to any interaction record created in CRM or in ERP. There are many different ways to link an interaction record to such a document created in a back-office process. One approach is explicitly manually to link a document to one or more interaction records in CRM, or in ERP with replication to CRM. And another approach is that at the moment when a customer calls about a document and the agent views this document, a new interaction record is then created with a linkage to this document.

In this example, the first search source can be the SAP CRM database and the second search source can be an SAP TREX enterprise database. A sub-search step to filter the result set of the main search of the first data source can use Business Object relations stored in Document Flow tables, and/or other tables.

The main search to the first search source (CRM database) targets two business objects: Business Partner and Interaction Record. A query is executed to get all Interaction Records related to the given Business Partner. From the result set of this search, a sub-search further filters using Document Flow and/or Categorization, and generates a result set of first main-search/sub-search.

The main search to the second search source (SAP TREX database) targets the same two business objects (Business Partner and Interaction Record) with extra, free-text search criterion. A query is executed to get all Interaction Records associated with the specified free-text for the given Business Partner. There is no sub-search for the second search.

Finally, the intersection of the first main-search/sub-search and the second main-search/sub-search is identified and displayed, stored, and or transmitted to a remote computing system.

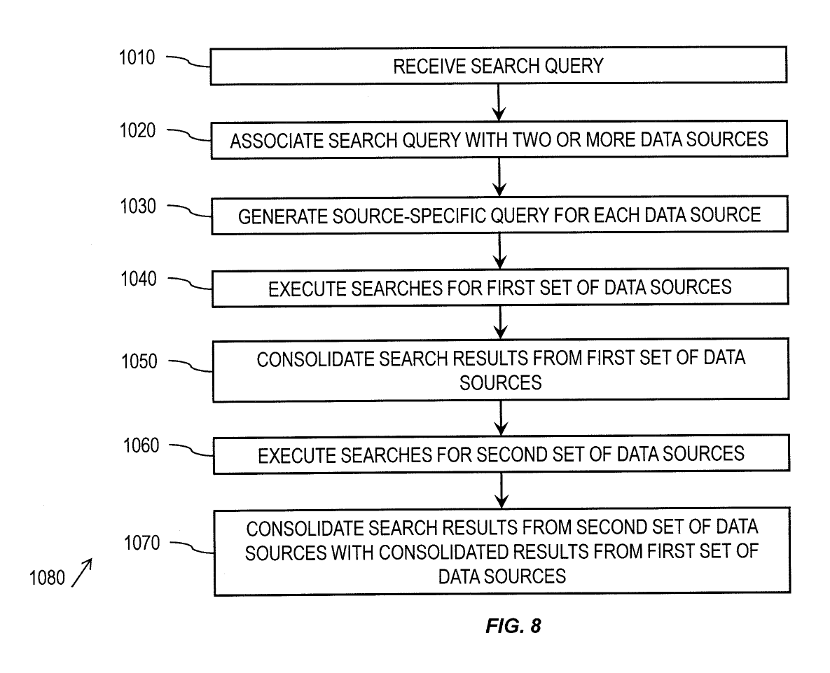

FIG. 8 is a further process flow diagram illustrating a method 1000 in which, at 1010, a search query is received. Thereafter, at 1020, the search query is associated with two or more data sources. Source-specific queries are generated, at 1030, for each data source using a data source definition associated with the corresponding data source and the search query. Searches are executed, at 1040, for a first set of data sources using the corresponding source-specific queries. The results of these searches are, at 1050, first consolidated. In parallel or thereafter, searches are executed, at 1060, for a second set of data sources using the corresponding source-specific queries. In some cases, the second set of data sources can have a lower priority than the first set of data sources. Subsequently, at 1070, the search results from the second set of data sources are consolidated with the consolidated search results from the first set of data sources. In some implementations, at least one search comprises a main search followed by a sub-search, the sub-search filtering results from the main search.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

1. A method comprising:
receiving a search query;
associating the search query with two or more data sources;
generating a source-specific query for each data source using a data source definition associated with the corresponding data source and the search query;
executing searches for a first set of data sources using the corresponding source-specific queries;
first consolidating the search results from the first set of data sources;
executing searches for a second set of data sources using the corresponding source-specific queries; and
second consolidating the search results from the second set of data sources with the consolidated search results from the first set of data sources;
wherein at least one search comprises a main search followed by a sub-search, the sub-search filtering results from the main search.

2. The method as in claim 1, further comprising:
receiving user-generated input via a graphical user interface specifying the search query.

3. The method as in claim 1, wherein at least one of the first set of data sources and the second set of data sources includes only one data source.

4. The method as in claim 1, wherein the second consolidating comprises finding a set of common entries from the search of the first set of data sources and from the search of the second set of data sources.

5. The method as in claim 1, further comprising:
providing the search results from the second consolidating.

6. The method as in claim 5, wherein the providing is selected from a group consisting of: displaying the search results in a computing display, persisting the search results, and transmitting the search results to a remote computing system.

7. The method as in claim 1, wherein at least a portion of the searches of first set of data sources are executed in parallel and/or at least a portion of the searches of the second set of data sources are executed in parallel.

8. The method as in claim 1, wherein at least a portion of the searches of first set of data sources are executed serially and/or at least a portion of the searches of the second set of data sources are executed serially.

9. The method as in claim 1, wherein at least a portion of the searches of first set of data sources are executed in parallel to at least a portion of the searches of the second set of data sources.

10. The method as in claim 1, wherein the searches of the second set of data sources are executed only after the searches of the first set of data sources are completely executed.

11. The method as in claim 1, wherein the searches of the second set of data sources are further limited by the consolidated search results from the first set of data sources.

12. The method as in claim 1, further comprising:
executing searches for a third set of data sources using the corresponding source-specific queries, the third set of data sources having a lower priority than both of the first set of data sources and the second set of data sources; and
third consolidating the search results from the third set of data sources with the search results consolidated from both of the first set of data sources and the second set of data sources.

13. The method as in claim 1, wherein the sub-search filters the results of the main search using object neighborhood search and/or categorization, wherein subsequent search queries only affecting linked neighborhood objects only result in a sub-search being executed while the main search results are reused.

14. The method as in claim 1, wherein source-specific queries for two different data sources query data encapsulated in common business objects.

15. The method as in claim 1, wherein the data source definitions specify priority levels for the data sources, and wherein the second set of data sources have a lower priority than the first set of data sources.

16. The method as in claim 1, further comprising:
determining a search strategy for the search query;
wherein the searches are performed using the determined search strategy.

17. A method comprising:
receiving a first search query initiated by a user via a graphical user interface, the first search query identifying a customer and seeking one or more interaction records associated with the customer;
associating the first search query with two or more data sources;
generating a source-specific query for each data source using a data source definition associated with the corresponding data source and the search query;
executing searches for a first set of data sources using the corresponding source-specific queries;
first consolidating the search results from the first set of data sources;
executing searches for a second set of data sources using the corresponding source-specific queries, the second set of data sources having a lower priority than the first set of data sources; and
second consolidating the search results from the second set of data sources with the consolidated search results from the first set of data sources, wherein the second consolidating filter the consolidated search results from the first set of data sources.

18. A computer program product comprising a non-transitory machine-readable medium storing instructions that, when executed by at least one programmable processor, cause the at least one programmable processor to perform operations comprising:
receiving a search query;
associating the search query with two or more data sources;
generating a source-specific query for each data source using a data source definition associated with the corresponding data source and the search query;
executing searches for a first set of data sources using the corresponding source-specific queries;
first consolidating the search results from the first set of data sources;
executing searches for a second set of data sources using the corresponding source-specific queries; and
second consolidating the search results from the second set of data sources with the consolidated search results from the first set of data sources;
wherein at least one search comprises a main search followed by a sub-search, the sub-search filtering results from the main search.

19. The computer program product as in claim 18, wherein the sub-search filters the results of the main search using object neighborhood search and/or categorization.

20. The computer program product as in claim 18, wherein the data source definitions specify priority levels for the data sources, and wherein the second set of data sources have a lower priority than the first set of data sources.
